(19) United States
(12) Patent Application Publication
(10) Pub. No.: US 2014/0200906 A1
(43) Pub. Date: Jul. 17, 2014

(54) DISPLAYING A STATISTICALLY SIGNIFICANT RELATION

(71) Applicant: MOTOROLA MOBILITY LLC, Libertyville, IL (US)

(72) Inventors: Frank R. Bentley, Chicago, IL (US); Paul C. Davis, Arlington Heights, IL (US); Jianguo Li, Chicago, IL (US); Di You, Grayslake, IL (US)

(73) Assignee: MOTOROLA MOBILITY LLC, Libertyville, IL (US)

(21) Appl. No.: 13/741,616

(22) Filed: Jan. 15, 2013

(51) Int. Cl. G06F 19/00; G06Q 50/22

(52) U.S. Cl. CPC G06F 19/34; G06Q 50/22
USPC 705/2

(57) ABSTRACT

The present disclosure teaches techniques for aggregating observations across multiple sensor-data streams and for presenting the results to users in meaningful ways. Available data are analyzed using a variety of statistical techniques. Significant correlations are presented to users to help them to identify any underlying informative patterns. The presented results help people gain insight into their habits as those habits affect their health and wellness. Users can then make informed decisions about their health, wellness, and environment.

### TECHNICAL FIELD

The present disclosure is related generally to status monitoring and, more particularly, to presentation of status information.

### BACKGROUND

Devices now exist that monitor aspects of a person's wellness on a regular basis. While once creating records of weight, body composition, heart rate, blood pressure, blood-sugar levels, calories expended per day, etc., were tasks that occurred irregularly or only at a doctor's office, current devices can make these measurement daily (or even more frequently) in the background while a person goes about his daily activities.

Fixed-location monitors and personal mobile devices can work together to capture contextual information about a person. Phones and tablets can capture the person's location, availability (from his calendar or phone state), speed of travel, mode of transportation, level of activity, ambient temperature, humidity, and many other aspects of the person's context.

Researchers are studying ways in which reflection on personal “wellbeing” data (e.g., as collected by the monitors discussed above) can be used to encourage positive behavioral changes. If applied (and accepted) broadly, these systems would positively impact the world by improving large-scale health conditions such as obesity and the resulting cardiovascular diseases that arise, saving the economy billions of dollars in medical costs.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an overview of a representative environment in which the present techniques may be practiced;

FIG. 2 is a generalized schematic of some of the devices shown in FIG. 1;

FIG. 3 is a flowchart of a method for presenting a relation among monitored data inputs;

FIG. 4 is a screenshot of a representative display produced by the method of FIG. 3;

FIG. 5 is a flowchart of a method for presenting an aggregation of relations among monitored data inputs; and

FIG. 6 is a screenshot of a representative display produced by the method of FIG. 5.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

Unfortunately, as the amount of “wellbeing” data increases, the ability for a typical user to make sense of these data decreases. With more and more sensors producing more and more observations, users become unable to extract meaningful information from the welter of data presented to them.

The present disclosure teaches techniques for aggregating observations across multiple sensor-data streams and for presenting the results to users in meaningful ways. Available data are analyzed using a variety of statistical techniques. Significant relations are presented to users to help them identify any underlying informative patterns. The patterns may relate to wellness, or to energy usage, or to other aspects of the user's environment. (The scope of results is limited only by the type of sensor information available.) When wellness relations are presented, for example, people can gain insight into their habits as those habits affect their health. Users can then make informed decisions about their health, wellness, and environment.

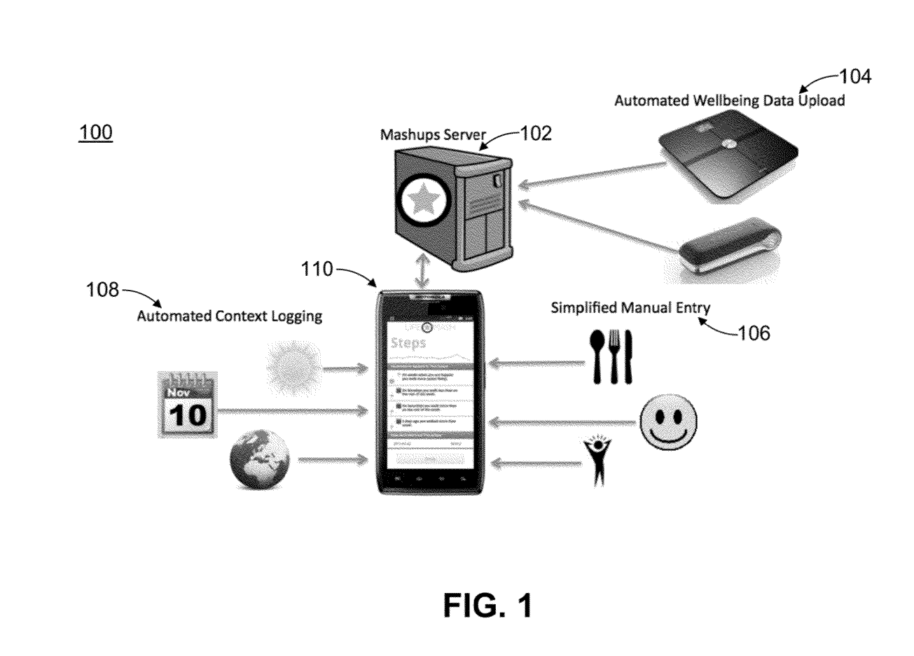

The present techniques can be practiced in an environment 100 such as the one shown in FIG. 1. An “analysis server” 102 collects observations from multiple types of sensors 104, 106, 108.

Some of these sensors 104 produce observations that are clearly related to wellness. They may automatically report their observations. These can include the current weight of the user (as reported by a bathroom scale), blood pressure, heart rate, blood-sugar level, number of steps taken in a day (or another measure of calories expended), and the like.

“Sensor” is to be understood very widely. Some “sensors” 106 are actually manual entries by the user. For example, the user may enter into an electronic diary the amount and type of food he eats at every meal, how much sleep he is getting, and the state of his emotional health.

Still other sensors 108 record aspects of the user's context that may relate to his wellness. Observations can include the current weather as it affects the user, indoor temperature and humidity, and his current geographical location. Other sensors can report on, say, a current thermostat setting, appliance (e.g., television) and water use, and status (i.e., open or closed) of windows and doors.

As described in more detail below, the analysis server 102 analyzes the sensor observations and presents them in a meaningful way to the user via an end-user device 110, such as his cellphone, tablet, or personal computer.

Note that some of the sensor observations may be directly recorded on the end-user device 110. These observations may then be sent to the analysis server 102. In general, the analysis server 102 and the end-user device 110, though depicted as separate devices in FIG. 1, are actually functions that can be performed by a number of devices, depending upon a specific implementation. In some implementations, the analysis server 102 gathers observations from many users and uses those observations to improve its results. In other implementations, the functions of the analysis server 102 are performed by the end-user device 110, making for a self-contained system.

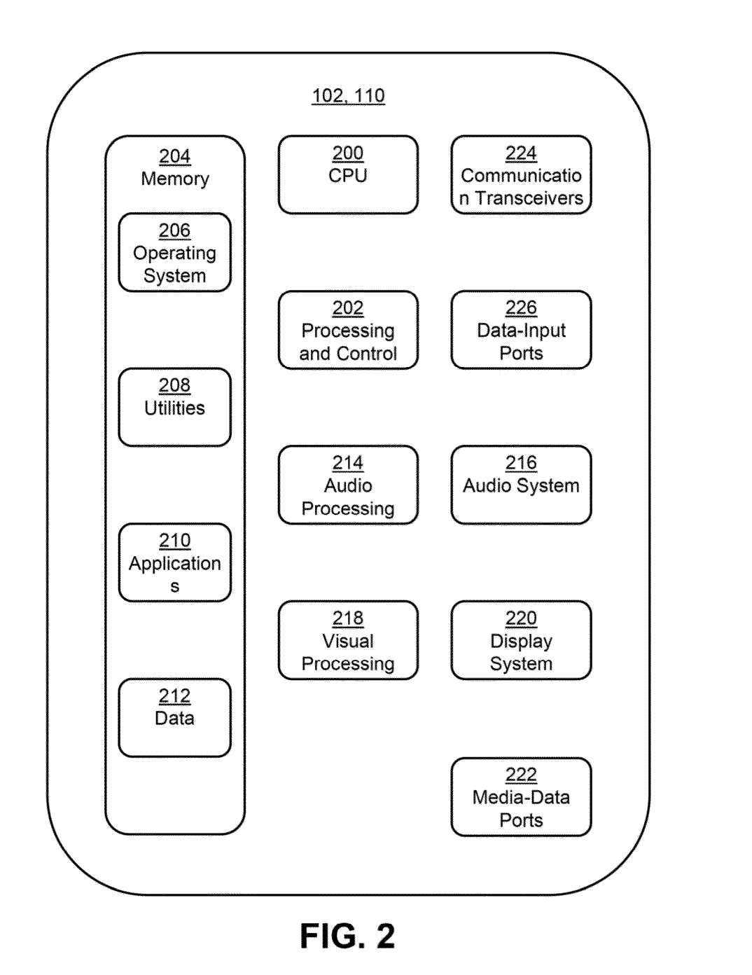

FIG. 2 shows the major components of a representative analysis server 102 or end-user device 110 (which, as explained above, could actually be the same device). The computing device 102, 110 of FIG. 2 could even be a plurality of servers working together in a coordinated fashion.

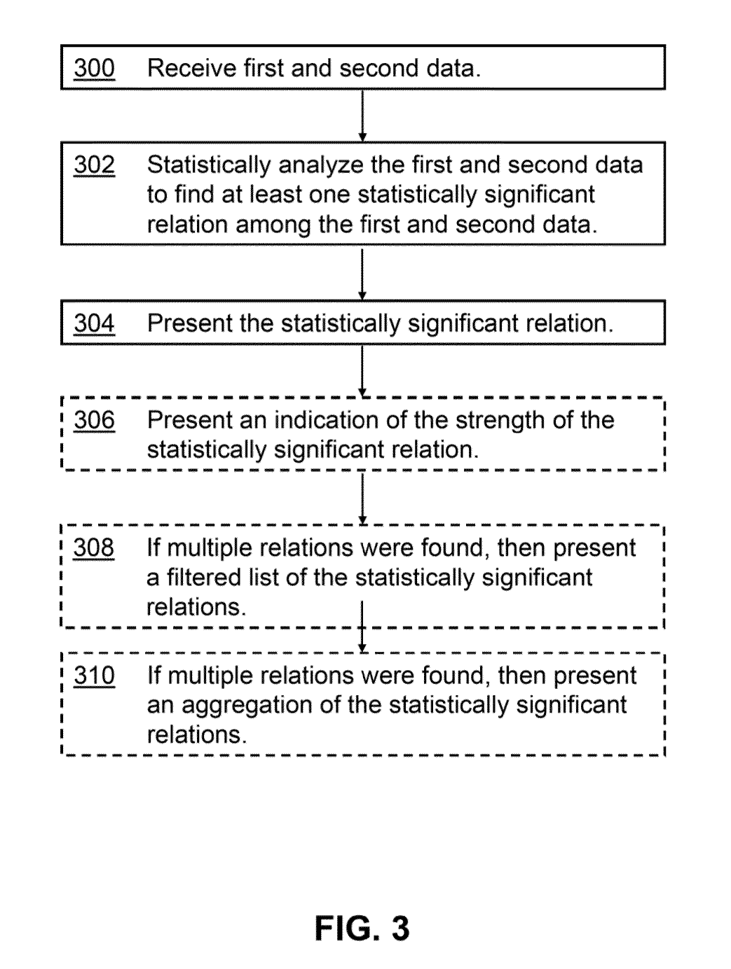

The CPU 200 of the computing device 102, 110 includes one or more processors (i.e., any of microprocessors, controllers, and the like) or a processor and memory system which processes computer-executable instructions to control the operation of the device 102, 110. In particular, the CPU 200 supports aspects of the present invention as illustrated in FIGS. 3 through 6, discussed below. The device 102, 110 can be implemented with a combination of software, hardware, firmware, and fixed-logic circuitry implemented in connection with processing and control circuits, generally identified at 202. Although not shown, the device 102, 110 can include a system bus or data transfer system that couples the various components within the device 102, 110. A system bus can include any combination of different bus structures, such as a memory bus or memory controller, a peripheral bus, a universal serial bus, and a processor or local bus that utilizes any of a variety of bus architectures.

The computing device 102, 110 also includes one or more memory devices 204 that enable data storage, examples of which include random-access memory, non-volatile memory (e.g., read-only memory, flash memory, EPROM, and EEPROM), and a disk storage device. A disk storage device may be implemented as any type of magnetic or optical storage device, such as a hard disk drive, a recordable or rewriteable disc, any type of a digital versatile disc, and the like. The device 102, 110 may also include a mass-storage media device.

The memory system 204 provides data-storage mechanisms to store device data 212, other types of information and data, and various device applications 210. An operating system 206 can be maintained as software instructions within the memory 204 and executed by the CPU 200. The device applications 210 may also include a device manager, such as any form of a control application or software application. The utilities 208 may include a signal-processing and control module, code that is native to a particular component of the computing device 102, 110, a hardware-abstraction layer for a particular component, and so on.

The computing device 102, 110 can also include an audio-processing system 214 that processes audio data and controls an audio system 216 (which may include, for example, speakers). A visual-processing system 218 processes graphics commands and visual data and controls a display system 220 that can include, for example, a display screen. The audio system 216 and the display system 220 may include any devices that process, display, or otherwise render audio, video, display, or image data. Display data and audio signals can be communicated to an audio component or to a display component via a radio-frequency link, S-video link, High-Definition Multimedia Interface, composite-video link, component-video link, Digital Video Interface, analog audio connection, or other similar communication link, represented by the media-data ports 222. In some implementations, the audio system 216 and the display system 220 are components external to the device 102, 110. Alternatively (e.g., in a cellular telephone), these systems 216, 220 are integrated components of the device 102, 110.

The computing device 102, 110 can include a communications interface which includes communication transceivers 224 that enable wired or wireless communication. Example transceivers 224 include Wireless Personal Area Network radios compliant with various IEEE 802.15 standards, Wireless Local Area Network radios compliant with any of the various IEEE 802.11 standards, Wireless Wide Area Network cellular radios compliant with 3GPP standards, Wireless Metropolitan Area Network radios compliant with various IEEE 802.16 standards, and wired Local Area Network Ethernet transceivers.

The computing device 102, 110 may also include one or more data-input ports 226 via which any type of data, media content, or inputs can be received, such as user-selectable inputs (e.g., from a keyboard, from a touch-sensitive input screen, or from another user-input device), messages, music, television content, recorded video content, and any other type of audio, video, or image data received from any content or data source. The data-input ports 226 may include USB ports, coaxial-cable ports, and other serial or parallel connectors (including internal connectors) for flash memory, storage disks, and the like. These data-input ports 226 may be used to couple the device 102, 110 to components, peripherals, or accessories such as microphones and cameras.

FIG. 3 presents a representative method for collecting observations and for presenting meaningful results to a user. In step 300, the analysis server 102 receives observations from sensors such as the sensors 104, 106, 108 described above in reference to FIG. 1. Step 300 recites “first and second data” to emphasize that different types of observations are collected.

The collection process of step 300 is generally ongoing, with different types of sensors 104, 106, 108 reporting observations at different times and with different frequencies. For example, manual-entry sensors 106 report whenever the user makes an entry or when the entries are periodically downloaded to the analysis server 102. Context sensors 108 may be queried, and their observations (e.g., the current time of day or day of the week) taken and associated with observations of other sensors. For example, an automated bathroom scale 104 may report the user's current weight when he steps on the scale 104, and that weight observation may then be automatically recorded in association with a time-of-day observation or current weather observation from a context sensor 108.

The analysis server 102 analyzes at least some of the recorded observations in step 302. Some of the results are very straightforward and easy for the user to interpret, such as the average number of steps (or average calories consumed) per day over the past week. Rather than stopping with those types of results, however, the analysis server 102 applies statistical techniques to the observations looking for meaningful relations among the observations, relations that may not be immediately apparent if the user had to view a long list of all of the observations made recently by all of the sensors 104, 106, 108.

Well known statistical techniques (e.g., correlation, t-test, standard deviation, erratic-pattern detection, acceleration-effect detection, binary-effect detection, presence-of-change-effect detection, value-range-effect detection) can be used to ferret out statistically significant relations. In addition, some embodiments apply expert knowledge to eliminate from consideration relations that would be either obvious or meaningless to the user (e.g., more steps taken correlates with more calories expended for a user whose chief exercise is walking) Negative relations can also be found.

In step 302, the analysis server 102 can also use information beyond the observations from the sensors 104, 106, 108. As one example, behavioral or profile information for the user may be available for analysis. In addition to user-preference data and passive usage data, the analysis server 102 may have access to a statistical aggregation of behavioral data from multiple users that can help it to interpret the user-specific observations it is receiving.

At least some of the results produced by the analysis server 102 are presented to the user in step 304. This presentation may, for example, be made by an application running on the user's end-user device 110.

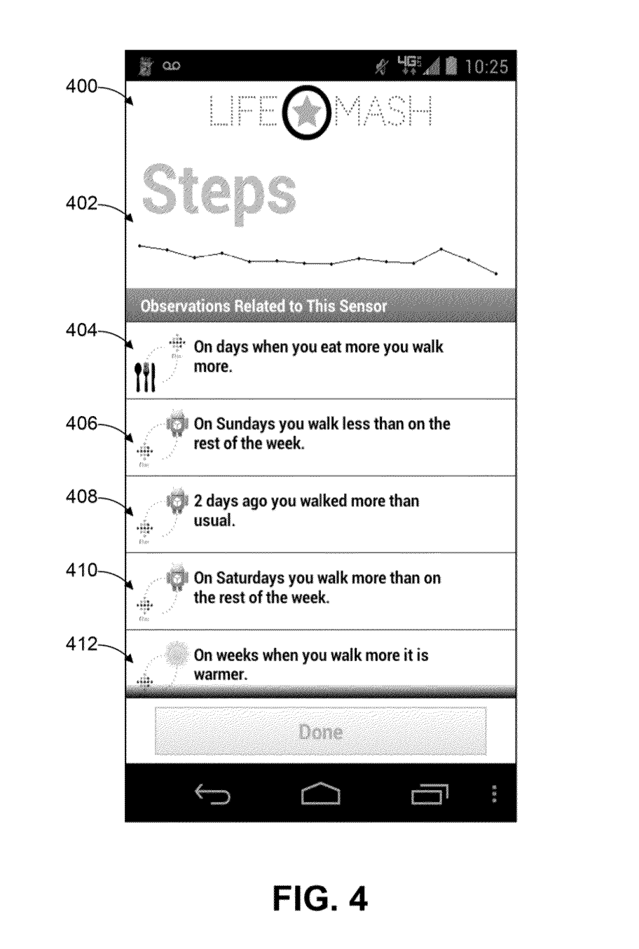

Before proceeding to discuss the optional steps 306 through 310, turn to FIG. 4. This is a representative screen shot 400, produced, according to aspects of the present invention, by an application running on the end-user device 110.

Because so many types of observations may be collected, this screen shot 400 identifies itself as dealing primarily with observations related to the number of steps the user takes. Item 402 shows this and gives a simple graph of the number of steps the user has taken per day over the past two weeks or so.

Items 404 through 412 are more interesting: They are relations found by the analysis server 102 as it analyzed observations from the many sensors 104, 106, 108. The analysis server 102 found a “statistically significant” relation between caloric intake and steps taken. (“Statistical significance” is a well known concept, and different statistical techniques determine significance in different ways. Any well known technique may be applied.) Item 404 presents this useful information to the user as “On days when you eat more, you walk more.” This is exactly the type of information that can be very useful to the user, but that he would probably miss if presented only with simple, undigested lists of sensor observations. It should be emphasized that because the relations presented in items 404 through 412 are statistically significant, that is to say, not every possible relation is shown (which could overwhelm the user almost as quickly as presenting all of the raw observations), only those relations are shown that may reflect an underlying truth and are therefore potentially useful for the user.

Items 406 and 410 relate steps taken with the day of the week: Sundays, the user walks less than on average, Saturdays he walks more. Note that in presenting these relations, the analysis server 102 is not making any judgments or even presenting any recommendations to the user: There may be perfectly acceptable reasons why the user walks less on Sundays. The relation, an objective fact, is presented to the user who then decides how, and if, he should modify his behavior accordingly.

The significance of item 408 is somewhat different than that of the other relations: Item 408 presents a one-time result but a result that represents a statistically significant deviation from the norm. (Clearly, it would not be useful to tell the user that he walked an insignificant number of steps more or less than he usually does.) In some situations, the analysis server 102 does not have enough information to provide a “hint” as to the cause of this statistically significant aberration. In other situations, an explanation may be offered: The user did not go in to work that day and so may be had more free time than usual. As always, by restricting the presented items 404 through 412 to statistically significant relations, the user can quickly focus on underlying realities rather than on unimportant numerical anomalies.

Finally, step 412 presents what may be an obvious relation, especially if the user lives in an area with severe winters: The user walks more when it is warmer.

To ease the intellectual burden on the user, these relations 404 through 412 may be presented (as they are in FIG. 4) without any indication of how long these relations have existed (or how many observations support them). (This does not apply to the one-time observation 408, of course.) A sophisticated user may find such trending information very helpful, to show how his behavior is evolving over time. For example, the user walked so many steps on average the past week, and that is 20% more than his average from a year ago.

Returning to FIG. 3, step 306 optionally presents a indication of the strength of a relation. While sophisticated users may like this, experiments show that many people are merely confused by this information.

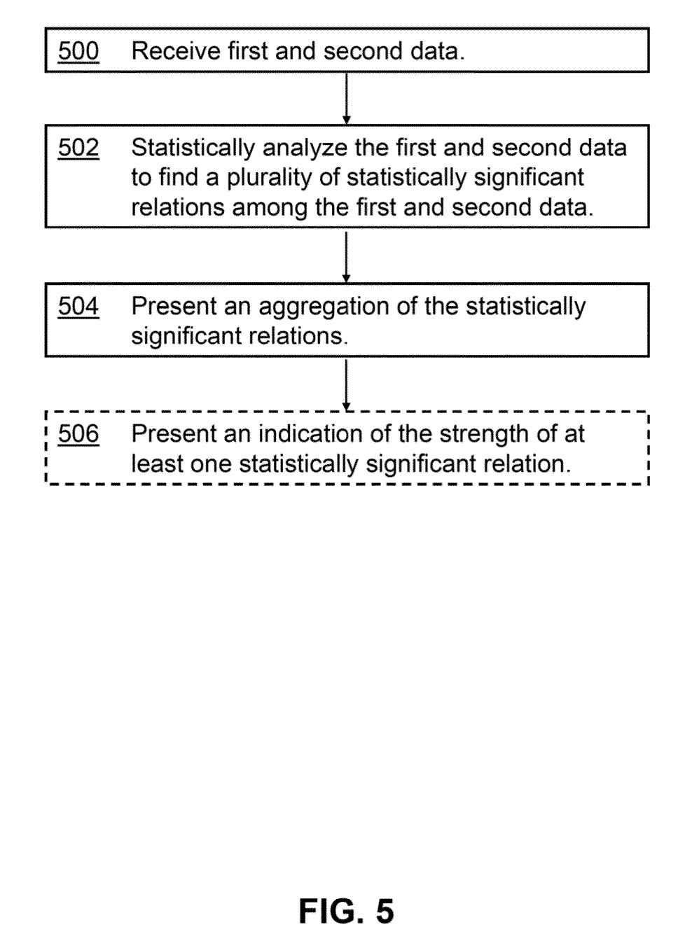

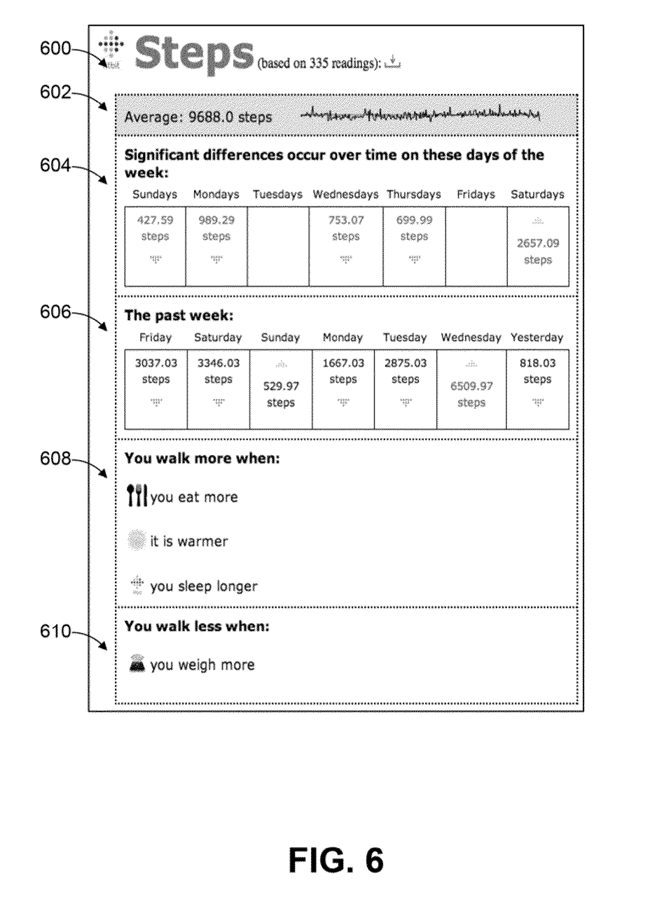

During its analysis in step 302, the analysis server 102 may find a number of statistically significant relations. Because some of these relations, though real, may be less informative than others, optional step 308 presents only a filtered list of the relations found. In addition, or alternatively, a number of significant relations can be presented in an aggregated fashion to the user in step 310. This possibility is discussed in greater detail below in relation to FIGS. 5 and 6.

The method of FIG. 5 can be performed instead of or, more likely, in parallel with, the method of FIG. 3. In step 500, the analysis server 102 gathers observations from the sensors 104, 106, 108, just as described above in relation to step 300 of FIG. 3.

In step 502, the observations (and possibly other relevant data) are statistically analyzed by the analysis server 102, just as in step 302 of FIG. 3, and significant relations are found.

Rather than simply presenting a list of the relations found (as shown in items 404 through 412 of FIG. 4), or even a filtered list (as in step 308 of FIG. 3), the analysis server 102 in step 504 attempts to lessen the burden on the user, and to increase the information value of its output, by intelligently aggregating related results.

FIG. 6 gives examples of aggregations. The screen shot 600 again identifies itself as based primarily on recordings of the user's steps (as in the screen shot 400 of FIG. 4). The simple graph 402 of FIG. 4 is replaced by a more informative average step count 602 and by two aggregation items 604, 606. Item 604 shows how, over time, the user's average step count varies by day of the week. For example, on Tuesdays and Fridays, the user tends to walk near his daily average (as indicated by the lack of display for these days), but walks almost 1000 steps fewer than his daily average on Mondays. The aggregation of item 606 is more specific, showing how the user's steps in the immediately preceding week varied from his average. In experiments, many users find the presentation of aggregates as in items 604 and 606 to be more meaningful (that is, more readily interpretable) than graphs like item 402 of FIG. 4.

The combination of items 608 and 610 presents another type of aggregation. Item 608 aggregates relations between step count and (1) calories consumed, (2) temperature, and (3) amount of sleep. Item 610 presents a similar relation, but one where the relation is negative: The user walks less when his reported weight is greater. By putting these four relations together in one display, users can often see widespread underlying patterns in their behavior.

As in step 306 of FIG. 3, the analysis server 102, in step 506, optionally presents an indication of the statistical strength of one or more relations or aggregations.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method for an analysis server to present a statistically significant relation, the method comprising:
receiving, by the analysis server, first data and second data, the first data distinct from the second data, the first and second data selected from the group consisting of: health-monitoring data associated with a person, home-monitoring data, and contextual data;
statistically analyzing, by the analysis server, the first and second data to find at least one statistically significant relation among the first data and the second data; and
presenting, by the analysis server, the at least one statistically significant relation.

2. The method of claim 1 wherein the health-monitoring data comprise a measurement selected from the group consisting of: heart rate, blood pressure, blood-sugar level, steps taken, weight, mood, diet, calories expended, and amount of sleep.

3. The method of claim 1 wherein the home-monitoring data comprises an element selected from the group consisting of: thermostat setting, indoor temperature, indoor humidity, appliance use, television use, water use, door status, and window status.

4. The method of claim 1 wherein the contextual data comprise an element selected from the group consisting of: date, day of the week, weather, temperature, humidity, and physical location.

5. The method of claim 1 wherein statistically analyzing comprises applying a technique selected from the group consisting of: correlation, t-test, standard deviation, erratic-pattern detection, acceleration-effect detection, binary-effect detection, presence-of-change-effect detection, and value-range-effect detection.

6. The method of claim 1 wherein statically analyzing comprises analyzing behavioral data associated with the person.

7. The method of claim 6 wherein the behavioral data comprise an element selected from the group consisting of: a preference explicitly stated by the person, a preference explicitly stated by something other than the person, passive usage data, passive contextual data, and a statistical aggregation of behavioral data.

8. The method of claim 1 wherein presenting comprises rendering a message about the statistically significant relation to a display of an end-user device.

9. The method of claim 1 wherein presenting comprises sending a message about the statistically significant relation to an end-user device.

10. The method of claim 1 further comprising:
presenting an indication of a strength of the statistically significant relation.

11. The method of claim 1 further comprising:
statistically analyzing the first and second data to find a plurality of statistically significant relations among the first data and the second data; and
filtering the plurality of statistically significant relations;
wherein presenting comprises presenting a filtered list of statistically significant relations.

12. The method of claim 1 further comprising:
statistically analyzing the first and second data to find a plurality of statistically significant relations among the first data and the second data;
wherein presenting comprises presenting an aggregation of the plurality of statistically significant relations.

13. An analysis server configured for presenting a statistically significant relation, the analysis server comprising:
a communications interface configured for receiving first data and second data, the first data distinct from the second data, the first and second data selected from the group consisting of: health-monitoring data associated with a person, home-monitoring data, and contextual data; and
a processor operatively connected to the communications interface and configured for:
statistically analyzing the first and second data to find at least one statistically significant relation among the first data and the second data; and
presenting the at least one statistically significant relation.

14. The analysis server of claim 13 wherein the analysis server is selected from the group consisting of: a personal electronics device, a mobile telephone, a personal digital assistant, a tablet computer, a compute server, and a coordinated group of compute servers.

15. A method for an analysis server to present a statistically significant relation, the method comprising:
receiving, by the analysis server, first data and second data, the first data distinct from the second data, the first and second data selected from the group consisting of: health-monitoring data associated with a person, home-monitoring data, and contextual data;
statistically analyzing, by the analysis server, the first and second data to find a plurality of statistically significant relations among the first data and the second data; and
presenting, by the analysis server, an aggregation of the plurality of statistically significant relations.

16. The method of claim 15 wherein the health-monitoring data comprise a measurement selected from the group consisting of: heart rate, blood pressure, blood-sugar level, steps taken, weight, mood, diet, calories expended, and amount of sleep.

17. The method of claim 15 wherein the home-monitoring data comprises an element selected from the group consisting of: thermostat setting, indoor temperature, indoor humidity, appliance use, television use, water use, door status, and window status.

18. The method of claim 15 wherein the contextual data comprise an element selected from the group consisting of: date, day of the week, weather, temperature, humidity, and physical location.

19. The method of claim 15 wherein statistically analyzing comprises applying a technique selected from the group consisting of: correlation, t-test, standard deviation, erratic-pattern detection, acceleration-effect detection, binary-effect detection, presence-of-change-effect detection, and value-range-effect detection.

20. The method of claim 15 wherein statically analyzing comprises analyzing behavioral data associated with a person.

21. The method of claim 20 wherein the behavioral data comprise an element selected from the group consisting of: a preference explicitly stated by the person, a preference explicitly stated by something other than the person, passive usage data, passive contextual data, and a statistical aggregation of behavioral data.

22. The method of claim 15 wherein presenting comprises rendering a message about the aggregation of statistically significant relations to a display of an end-user device.

23. The method of claim 15 wherein presenting comprises sending a message about the aggregation of statistically significant relations to an end-user device.

24. The method of claim 15 further comprising:
presenting an indication of a strength of at least one statistically significant relation.

25. An analysis server configured for presenting a statistically significant relation, the analysis server comprising:
a communications interface configured for receiving first data and second data, the first data distinct from the second data, the first and second data selected from the group consisting of: health-monitoring data associated with a person, home-monitoring data, and contextual data; and
a processor operatively connected to the communications interface and configured for:
statistically analyzing, by the analysis server, the first and second data to find a plurality of statistically significant relations among the first data and the second data; and
presenting, by the analysis server, an aggregation of the plurality of statistically significant relations.

26. The analysis server of claim 25 wherein the analysis server is selected from the group consisting of: a personal electronics device, a mobile telephone, a personal digital assistant, a tablet computer, a compute server, and a coordinated group of compute servers.
